(19) United States
(12) Patent Application Publication
(10) Pub. No.: US 2007/0112695 A1
(43) Pub. Date: May 17, 2007

(54) Hierarchical fuzzy neural network classification

(76) Inventors: Yan Wang, Milpitas, CA (US); Mohammad Jamshidi, San Antonio, TX (US)

Correspondence Address: MH2 TECHNOLOGY LAW GROUP, 1951 KIDWELL DRIVE, SUITE 550, TYSONS CORNER, VA, 22182, US

(21) Appl. No.: 11/319,536

(22) Filed: Dec. 29, 2005

Related U.S. Application Data
(60) Provisional application No. 60/640,609, filed on Dec. 30, 2004.

(51) Int. Cl. G06F 15/18

(52) U.S. Cl. 706/2

(57) ABSTRACT

A method includes receiving data representing an object to be classified into classes and applying the data to a hierarchical fuzzy neural network. The hierarchical fuzzy neural network comprises multiple fuzzy neural networks arranged in a hierarchical structure. The method also includes classifying the data using the hierarchical fuzzy neural network.

### CROSS REFERENCE TO RELATED APPLICATIONS

This application claims priority to U.S. Provisional Patent Application Ser. No. 60/640,609 filed on Dec. 30, 2004, the disclosure of which is incorporated in its entirety by reference herein.

### FIELD

Embodiments of the invention generally relate to methods and systems for classifying data. Particularly, embodiments relate to methods and systems for classifying image data.

### BACKGROUND

Today, many different processes require classification of data. One such process is image analysis. For example, different portions of the image have to be classified as to features contained in the image. Remotely-acquired image classification involves grouping the image data into a finite number of discrete classes, for example classes of land cover type in terrain images.

Several conventional methods exist to group the image data. For example, a maximum likelihood classifier (MLC) method, widely used in remotely-acquired image classification, is based on the assumption that features, such as land cover, in the image follow normal data distribution. However, earth land cover does not occur randomly in nature and frequently is not displayed in the image data with a normal distribution.

Another conventional distribution method used in remotely-acquired image classification is Neural Network (NN) classification. The NN classification does not require a normal data distribution as in the MLC method. In NN classification, multiple classes, each class representing a type of land cover, are identified, and each class is represented by a variety of patterns to reflect the natural variability of the land cover. The NN classification works by training the neural network to recognize the patterns using training data and learning algorithms. The algorithms, however, cannot be interpreted by the human users. Normally, the neural network training and classification time may be long in order to adapt to these patterns. The time may range in some cases from a few hours to a few weeks on a conventional computer.

Also, the NN classification assumes that each pixel in the image represents a discrete land cover class. Typically, in remotely-acquired images, a pixel of the image may represent a mixture of classes, within-class variability, or other complex land cover patterns, which cannot be properly described by one class for the pixel. This non-discrete land cover may be caused by the characteristics of the land cover and the image spatial resolution.

Since one class cannot uniquely describe each pixel, fuzzy classification has been developed to supplement traditional classification. Fuzzy classification assumes that a pixel does or does not belong to a single class. In the fuzzy classification, each pixel belongs to a class within a certain degree of membership and the sum of all class degrees is 1. A fuzzy classification approach to image classification makes no assumption about the statistical distribution of the data and, so, reduces classification inaccuracies. A fuzzy classification allows for the mapping of a scene's natural fuzziness or imprecision, and provides more complete information for a thorough image analysis.

Several algorithms exist for fuzzy classification: Fuzzy c-means, Fuzzy-k Nearest Neighbor, and fuzzy MLC algorithms. Fuzzy c-means algorithm, as an unsupervised method, is widely used in the fuzzy classification. Fuzzy k-Nearest Neighbor and fuzzy MLC algorithms have also been applied to improve the classification accuracy. Typically, Fuzzy Rules Based classifiers are used for multi-spectral images with specific membership functions. Fuzzy classification, however, may not be able to distinguish between certain types of land class cover. Further, as the number of spectra increases, the number of rules in the classification increases. As such, the fuzzy classification may require significant computation power and time.

Fuzzy Neural Network (FNN) classification is another type of classification applied to remotely-acquired data classification. FNN classification combines the learning capability of neural networks in the fuzzy classification. In FFN, fuzzy classification is applied in neural networks to relate the outputs of the neural network to the class contribution in a given pixel. FFN classification, however, requires significant computing power when classifying multiple sets of data. As such, training and implementation of the system may require long periods of time.

Another classification system is a Fuzzy expert system, which is a type of fuzzy classification. The fuzzy expert system utilizes general membership functions and bases classification on human knowledge. Fuzzy expert systems are used in control systems, but are not typically utilized in image classification. In the fuzzy expert system, expert knowledge and training data are two common ways to build up fuzzy rules. With the natural variability and complicated patterns in the image data, it is difficult to incorporate complete fuzzy rules from expert knowledge to the classification system. Training data is required to obtain these rules, but, currently, there is no learning process to adapt to the patterns.

### SUMMARY

An embodiment of the invention concerns a method for classifying data. The method includes receiving data representing an object to be classified into classes and applying the data to a hierarchical fuzzy neural network. The hierarchical fuzzy neural network comprises multiple fuzzy neural networks arranged in a hierarchical structure. The method also includes classifying the data using the hierarchical fuzzy neural network.

Another embodiment of the invention concerns a system for classifying data. The system includes an input for receiving data representing an object to be classified into classes. The system also includes a processor configured to apply the data to a hierarchical fuzzy neural network, and classify the data using the hierarchical fuzzy neural network. The hierarchical fuzzy neural network comprises multiple fuzzy neural networks arranged in a hierarchical structure.

Yet another embodiment of the invention concerns a method of classifying image data. The method includes receiving data representing an object to be classified into classes. The data comprises multiple sets of data representing the object, each set of the multiple data sets including different information about the object. The method also includes building a fuzzy neural network using expert knowledge, applying the data to the fuzzy neural network, and classifying the data using the fuzzy neural network.

Additional embodiments will be set forth in part in the description which follows, and in part will be obvious from the description, or may be learned by practice of the invention. The embodiments will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments and together with the description, serve to explain the principles of the invention.

### BRIEF DESCRIPTION OF THE DRAWINGS

FIG. 1 is a diagram illustrating an exemplary hierarchical fuzzy neural network consistent with embodiments of the invention.

FIG. 2 is a diagram illustrating an exemplary fuzzy neural network consistent with embodiments of the invention.

FIG. 3 is a diagram illustrating an exemplary system consistent with embodiments of the invention.

FIG. 4 is a flowchart illustrating an exemplary method of using a hierarchical fuzzy neural network consistent with embodiments of the invention.

FIG. 5 is a flowchart illustrating an exemplary method of building a hierarchical fuzzy neural network consistent with embodiments of the invention.

FIG. 6 is a diagram illustrating an exemplary image classification hierarchical fuzzy neural network consistent with embodiments of the invention.

FIG. 7 is a diagram illustrating an exemplary image classification fuzzy neural network consistent with embodiments of the invention.

FIG. 8 is a diagram illustrating exemplary signature data consistent with embodiments of the invention.

FIGS. 9A-C are diagrams illustrating exemplary membership functions consistent with embodiments of the invention.

### DETAILED DESCRIPTION

Embodiments of the present invention concern fuzzy classification and hierarchical fuzzy classification. According to the embodiments, the speed of classification and accuracy is increased by arranging fuzzy neural networks in a hierarchical arrangement. Instead of applying all data sets as inputs into fuzzy neural networks, the number of data sets input into fuzzy neural networks is limited.

Also, instead of the fuzzy neural networks classifying the input data as a single class, the output of the fuzzy neural network is set to classify the data as groups of classes instead of the single class. To ultimately classify the data to a single class, the output of the fuzzy neural network representing a group of classes is inputted into another fuzzy neural network lower in the hierarchy along with another data set. The fuzzy neural network further classifies the data classified in the group of classes into a smaller group of classes based on the other data set. The data is fed to successive fuzzy neural networks lower in the hierarchy until the data is classified as individual classes.

Using the hierarchical structure, each fuzzy neural network receives limited input data sets. Accordingly, the structure of the fuzzy neural network is simpler and requires fewer rules. As such, the classification requires less computing power when classifying multiple sets of data. As such, training and implementation of the system requires less time.

Additionally, according to embodiments, a fuzzy neural network is combined with expert knowledge in training the network. By utilizing expert knowledge, the fuzzy neural network may be trained to more accurately classify data.

For simplicity and illustrative purposes, the principles of the present invention are described by referring mainly to exemplary embodiments thereof. However, one skilled in the art will readily recognize that the same principles are equally applicable to, and can be implemented in, all types of classification systems, and that any such variations do not depart from the true spirit and scope of the present invention.

Moreover, in the following detailed description, references are made to the accompanying figures, which illustrate specific embodiments. Electrical, mechanical, logical and structural changes may be made to the embodiments without departing from the spirit and scope of the present invention. The following detailed description is, therefore, not to be taken in a limiting sense and the scope of the present invention is defined by the appended claims and their equivalents.

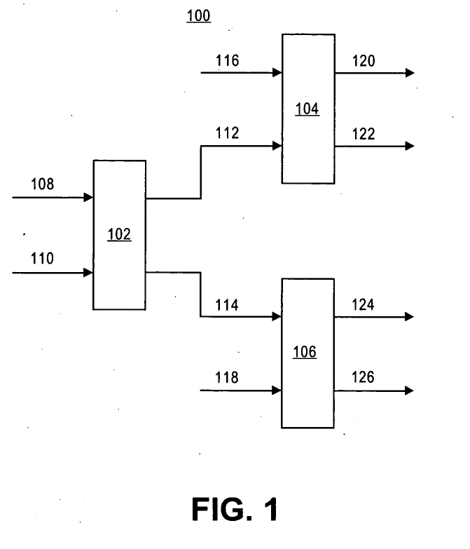

FIG. 1 is a diagram illustrating a hierarchical fuzzy neural network (HFNN) 100 for classifying data consistent with embodiments. It should be readily apparent to those of skilled in the art that HFNN 100 depicted in FIG. 1 represents a generalized schematic illustration and that other components may be added or existing components may be removed or modified.

HFNN 100 includes three separate fuzzy neural networks 102,104, and 106 arranged in a hierarchical structure. HFNN 100 is designed to classify an object based on multiple sets of data. Particularly, HFNN is designed to receive four sets of data 108, 110, 116, and 118 which represents some object with features to be classified. HFNN 100 is capable of classifying features of the object into four classes 120, 122, 124, and 126.

Instead of applying all data sets as inputs into fuzzy neural network 102, 104, and 106, the number of data sets input into a single fuzzy neural network 102, 104, and 106 is limited to two inputs. As such, instead of fuzzy neural networks 102, 104, and 106 classifying the input data as a single class, the output of the fuzzy neural network is set to successively classify the features in the object as belonging to a group of classes until the single classification is reached.

Particularly, HFNN 100 classifies the data in data set 108, 110, 116, and 118 by grouping classes 120, 122, 124, and 126. Classes 120, 122, 124, and 126 are compared and grouped into two groups of classes 112 and 114 based on a relationship between the classes. For example, classes with similar characteristics may be grouped together in the same group.

Then, fuzzy neural network is built and trained to classify data sets 108 and 110 as belonging to groups 112 and 114. By dividing the classes into groups, not all the data sets 108, 110, 116, and 118 need to be inputted into the each FNN 102, 104, and 106. Instead, two sets 108 and 110 are input into FFN 102. Sets 108 and 110 may be selected based on largest difference in input sets compared to the output classes.

FFN 102 would analyze sets 108 and 110 and classify the features in sets 108 and 110 as belonging to group 112 or group 114. The output of FNN 102 corresponding to group 112 may be then input into FNN 104 along with data set 116. FNN 104 would then analyze data set 116 and data classified as group 112. The analysis would classify the data as belonging to classes 120 or 122 which make up group 112.

Likewise, the other output of FNN 102 corresponding to data classified as belonging to group 114 may be input into FNN 106. FNN 106 may analyze data set 118 and data representing group 114. The analysis would classify the data as belonging to classes 124 or 126.

For example, HFNN 100 may be used to classify features of an image of an object into classes. In such an example, data set 108, 110, 116, and 118 may be different image information for the object, e.g. different spectral information. In such an example, classes 120, 122, 124, and 126 may represent features of the image of the object such as terrain types. One skilled in the art will realize that the image classification is an exemplary use of HFNN 100 and that any type data may be classified using HFNN 100.

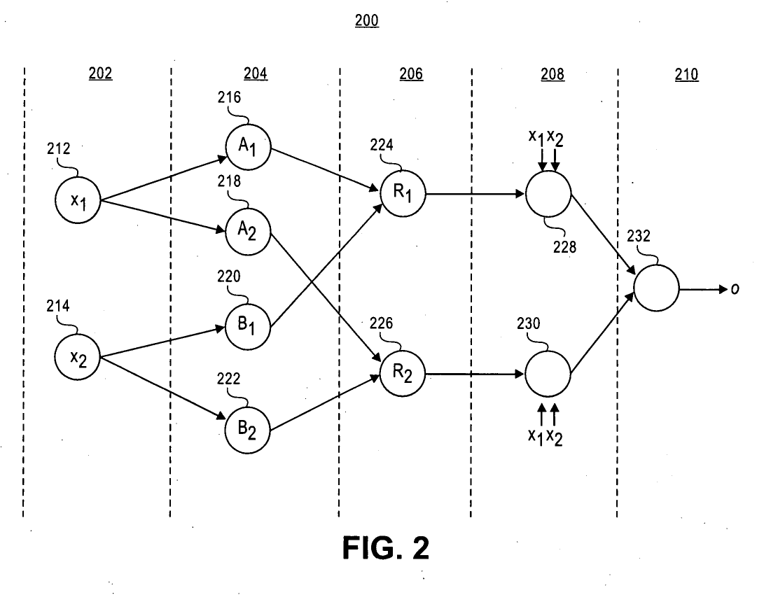

FIG. 2 is a diagram illustrating one type of FNN 200 which may be used as FNNs 102, 104, and 106. FNN may also be used in a standard linear arrangement to classify data. It should be readily apparent to those skilled in the art that FNN 200 depicted in FIG. 2 represents a generalized schematic illustration and that other components may be added or existing components may be removed or modified.

FNN 200 is a connectionist model for fuzzy rules implementation and inference, in which fuzzy rules prototypes are imbedded in a generalized neural network and are trained using training data, expert knowledge, or a combination of both. FNN 200 includes five different layers. Specifically, FNN 200 includes an input layer 202. Input layer 202 includes neurons 212 and 214. Neurons 212 and 214 represent input variables x₁ and x₂. Input variables would be taken from data sets being classified by the FNN 200.

FNN 200 also includes a fuzzification layer 204. Fuzzification layer 204 includes neurons 216, 218, 220, and 222. Neurons 216, 218, 220, and 222 represent fuzzy values A₁, A₂, B₁, and B₂. Fuzzy values A₁, A₂, B₁, and B₂ are fuzzy linguistic membership functions for FNN 200. Fuzzy values map the input variables into fuzzy data. The linguistic membership functions will be determined by the type of data being classified.

FNN 200 also includes a rule layer 206. Rule layer 206 includes neurons 224 and 226. Neurons 224 and 226 represent rules R₁ an R₂ used by FNN 200 for classifying data. For example, R₁ an R₂ may be represented by the equation:
R₁: If x₁ is A₁ and x₂ is B₁, then f₁=p₁₁x₁+p₁₂x₂+r
R₂: If x₁ is A₂ and x₂ is B₂, then f₂=p₂₁x1+p₂₂x₂+r

where pᵢⱼ are parameters in the output fᵢ of Ruleᵢ (i=1, 2).

FNN 200 also includes an action layer 208. Action layer 208 includes neurons 228 and 230. Neurons 228 and 230 represent fuzzy values of the output variables.

FNN 200 also includes an output layer 210. Output layer 210 includes neuron 232. Neuron 232 represents output variable o. Output variable o is the classification results from FNN 200.

Fuzzy rules in FNN 200 may be determined using expert knowledge. Also, learning algorithms may be utilized to train FNN 200 and determine the fuzzy rules. For example, the Adaptive-Neural-Network Based Fuzzy Inference System (ANFIS) may be used to establish fuzzy rules from training. In ANFIS, zeroth or first order Sugeno-type inference are used in the network. A gradient descent learning algorithm in combination with least squares estimate (hybrid leaning) may be used to adjust the parameters in R₁ and R₂. Also, learning algorithms in combination with expert knowledge may be used to train FNN 200. For example, the initial values may be selected by an expert and then the network trained using training data.

One skilled in the art will realize that FNN 200 is exemplary and that there are a wide variety of architectures for FNN 200. For example, FNN 200 may utilize different types of fuzzy rules, types of inference methods, and modes of operation. Moreover, FNN 200 may include additional layers and additional neurons in the layers.

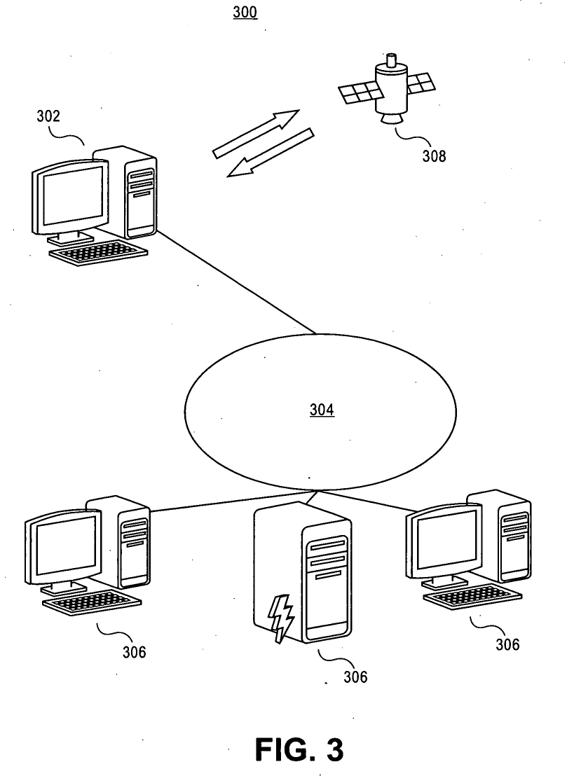

HFNN 100 may be embodied and utilized in various systems. FIG. 3 is a diagram illustrating an exemplary system 300 for utilizing HFNN 100. System 300 includes a computer 302. It should be readily apparent to those of skilled in the art that system 300 depicted in FIG. 3 represents a generalized schematic illustration and that other components may be added or existing components may be removed or modified.

Computer 302 includes the standard components of a computing device. For example, computer 302 may include a processor, memory, buses, video hardware, sound hardware, and input/output (“I/O”) ports. The processor may be, for example, a central processing unit (CPU), a micro-controller unit (MCU), digital signal processor (DSP), or the like.

The memory may be a read only memory (ROM), a random access memory (RAM), or a memory with other access options. The memory may be physically implemented by computer-readable media, such as, for example; magnetic media, such as a hard disk, a floppy disk, or other magnetic disk, a tape, a cassette tape; optical media, such as optical disk (CD-ROM, DVD); semiconductor media, such as DRAM, SRAM, EPROM, EEPROM, or memory stick. Further, portions of the memory may be removable or non-removable.

The memory may store and support modules, for example, a basic input output system (BIOS), an operating system (OS), a program library, a compiler, an interpreter, a text-processing tool, and other programs such as database, word-processor, web-browser, and voice-recognition.

Computer 302 may also include a display screen such as a liquid crystal display, plasma display, or cathode ray tube display. Computer 302 may include input/output devices such as a keyboard, mouse, microphone, and speakers. Computer 302 may also include network hardware such as a network interface card for connecting with network 308.

System 300 may also be coupled to other computers 306 via network 304. Network 304 may be any type of network such as an internet, the Internet, a wide area network, or a local area network. Computers 306 may contain the same components as computer 302. Any of computers 306 may also be a server computer.

Computer 302 may also be coupled to data acquisition device 308. Data acquisition device 308 may be any type of device for detecting, sensing, reading, or recording information. For example, data acquisitions device 308 may be an imaging satellite. Computer 302 may be coupled to data acquisition device 308 via input/output ports or network 304. Computers 306 may also be coupled to data acquisition device 308.

HFNN 100 may be embodied in computer 302 as hardware, software, or any combination thereof. HFNN 100 may classify data stored at computer 302, data received from computers 306, or data received from data acquisitions device 308. Further, HFNN 100 may be embodied on computers 306 or combinations of computer 302 and 306.

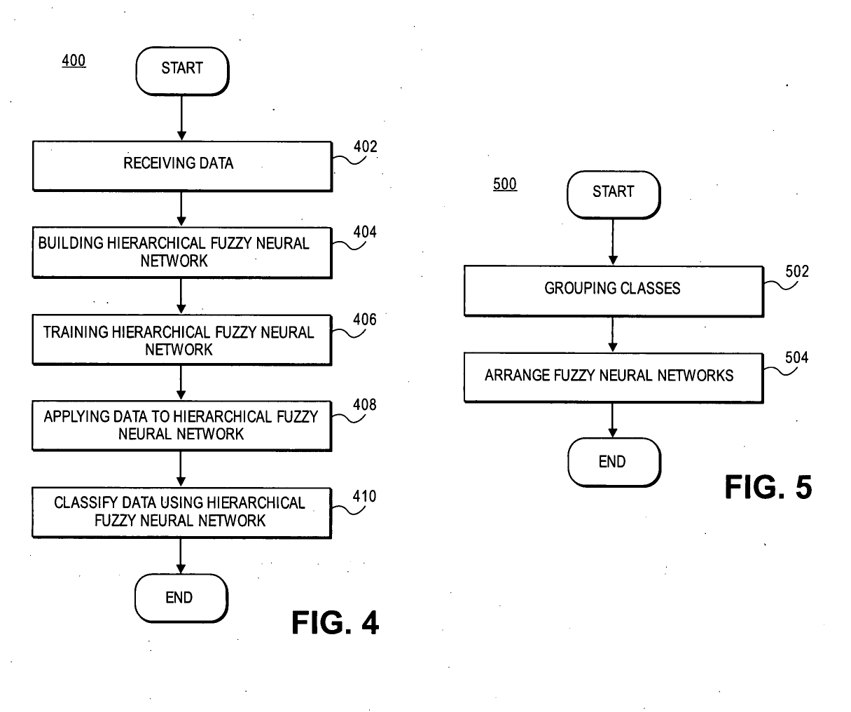

FIG. 4 is a flowchart illustrating a method 400 for using HFNN 100 for classifying data. For example, method 400 may be performed using system 300 illustrated in FIG. 3.

Method 400 begins by receiving data representing an object to be classified into classes of features (stage 402). If computer 302 is utilized, computer 302 may receive the data from data acquisition device 308 or computers 306. Also, the data representing the object may be stored at computer 302.

Then, HFNN 100 is built (stage 404). HFNN 100 is built by determining the arrangement and structure of FNNs in the HFNN 100 hierarchy. The arrangement and structure may be determined using expert knowledge, training data, or combination thereof. For example, if system 300 is utilized, a user with expert knowledge may build the network using computer 302. Computer 302 may build HFNN 100 by determining the arrangement and structure of FNNs in the HFNN 100 hierarchy.

FIG. 5 is a flowchart illustrating a method 500 for building HFNN 100. Method 500 begins with grouping the classes of features in the object into groups (stage 502). Computer 302 may determine the grouping of classes 120, 122, 124, and 126 to be classified by FNN 102 as groups 112 and 114. Classes 120, 122, 124, and 126 may be compared and grouped into two groups of classes 112 and 114 based on a relationship between the classes. For example, classes with similar characteristics may be grouped together in the same group.

Computer 302 may then determine the proper FNNs for HFNN 100 and arranged the FNNs (stage 504). If computer 302 is utilized, computer 302 may determine the appropriate FNN structure in order to classify data as belonging to groups 112 and 114. Computer 302 may then determine the proper data set 108 and 110 to be input into FNN 102 to best classify the data as belonging to groups 112 and 114. For example, sets 108 and 110 may be selected based on largest difference in input sets compared to the output classes. Next, computer 302 determines the proper FNN for FNN 104 and FNN 106. Computer 302 also determines the proper input data sets 116 and 118.

After the HFNN 100 is built, HFNN 100 may be trained to classify data (stage 406). HFNN 100 may be trained using learning algorithms, expert knowledge, or combinations thereof. If computer 302 is utilized, computer 302 may determine the fuzzy rules in FNNs 102, 104, and 106. Fuzzy rules in FNNs 102, 104, and 106 may be determined using expert knowledge. Also, learning algorithms may be utilized to train FNN 100 and determine the fuzzy rules. Also, learning algorithms in combination with expert knowledge may be used to train FNN 200. For example, the initial values may be selected by expert knowledge and then the network trained using training data.

After HFNN 100 is trained, the data to be classified is applied to HFNN 100 (stage 408). If computer 302 is utilized, computer 302 may retrieve the data to be classified and apply the data to HFNN 100 according to the structure of HFNN 100 determined in stage 404.

Then, the data is classified using HFNN 100 (stage 410). Once the data is classified using HFNN 100, computer 302 may utilize the data for any purpose.

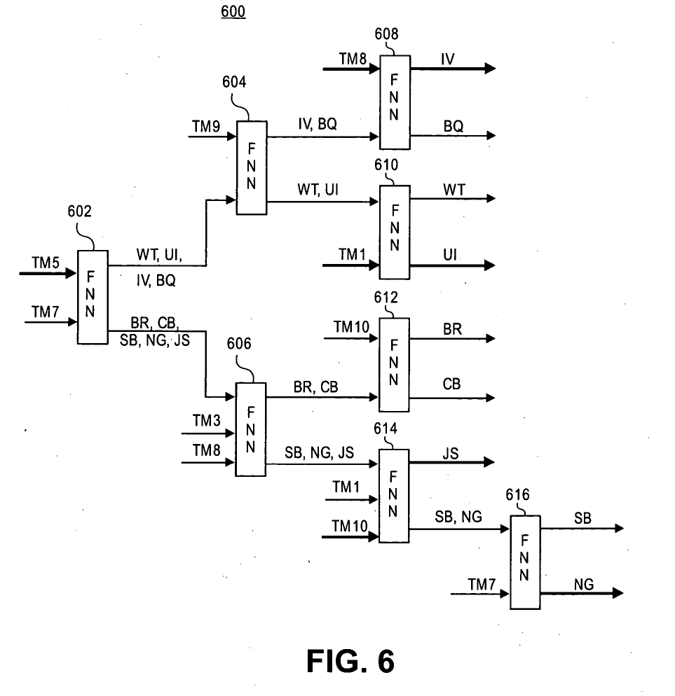

FIG. 6 is a diagram illustrating an exemplary HFNN 600 for performing image classification consistent with embodiments of the invention. HFNN 600 may be embodied on a processing system such as computer 302 in system 300. Particularly, HFNN 600 performs land cover classification of an image using multi-spectral data. It should be readily apparent to those of skilled in the art that HFNN 600 depicted in FIG. 6 represents a generalized schematic illustration and that other components may be added or existing components may be removed or modified.

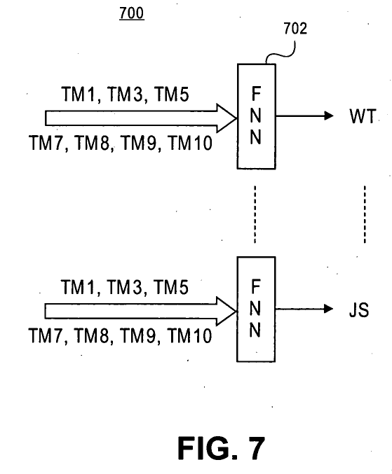

FIG. 7 is a diagram, illustrating a linear FNN 700 which also performs land cover classification of an image using multi-spectral data consistent with embodiments. FNN 700 may be embodied on a processing system such as computer 302 in system 300. It should be readily apparent to those of skilled in the art that FNN 700 depicted in FIG. 7 represents a generalized schematic illustration and that other components may be added or existing components may be removed or modified.

HFNN 600 and FNN 700 were used to analyze an image to determine land cover. HFNN 600 performed classification of a Landsat Enhanced Thematic Mapper Plus (ETM+) image. The Landsat 7 EMT+ is a nadir-viewing, multi-spectral scanning radiometer which provides image data for the Earth's surface via eight spectral bands. These bands range from the visible and near infrared (VNIR), the mid-infrared (Mid_IR), and the thermal infrared (TIR) regions of the electromagnetic spectrum. Table 1 includes the bands captured by Landstat 7 ETM+.

TABLE 1

| Band Number | Spectral Range (μm) | Ground Resolution (m) |
|---|---|---|
| TM1 (Vis-Blue) | 0.450-0.515 | 30 |
| TM2 (Vis-Green) | 0.525-0.605 | 30 |
| TM3 (Vis-Red) | 0.630-0.690 | 30 |
| TM4 (NIR) | 0.750-0.900 | 30 |
| TM5 (Mid-IR) | 1.550-1.750 | 30 |
| TM6 (TIR) | 10.40-12.50 | 60 |
| TM7 (Mid-IR) | 2.090-2.350 | 30 |
| TM8 (Pan) | 0.520-0.900 | 15 |

In addition to the spectral bands above, HFNN 600 used two non-spectral bands in the image classification: Normalized Difference Vegetation Index (NDVI), TM9, and Digital Elevation Model (DEM), TM10: NDVI, TM9, was used to discriminate between the land cover's vegetation responses. A scaled NDVI for display is computed by:
Scaled NDVI=100*[TM4−TM3/(TM4+TM3)+1]

In the above equation, TM4 is the near-infrared band and TM3 is the visible red band with values greater than 100 indicating an increasing vegetation response, and lower values (as they approach 0) indicating an increasing soil response. DEM, TM10 was used to discriminate between some land cover found at higher elevation and lower elevations.

In this example, the image for classification by HFNN 600, was initially obtained as a level 1G data product through pixel reformatting, radio metric correction, and geometric correction. Data was quantized at 8 bits. The image used in this example was acquired over the Rio Rancho New Mexico and is 744 lines×1014 lines (754,416 pixels) total for each band. Nine types of land cover which will be classified as classes are identified in this area—water (WT), urban imperious (UI), irrigated vegetation (IV), barren (BR), caliche-barren (CB) bosque/riparian forest (BQ), shrubland (SB), natural grassland (NG), and juniper savanna (JS).

For the purpose of testing and training HFNN 600, regions of interest (ROIS) were extracted from the image. ROIs are groups of image pixels which represent known class features or ground-truth data. The known class labels are based on information gathered in the field, using a global positioning system (GPS) to record the location and the map unit that the class was identified. Sixty-nine total field areas are located on the image and representative polygons are created using a region forming method by ERDAS IMAGINE.

In ROI polygon creation, a distance and maximum number of pixels are set for the polygon (or linear) region. The known class features' continuous pixels within predefined spectral distances are included in the ROIs. From these seed polygons, basic, descriptive statistics are gathered from each of the pixels in the seed polygons for each of the bands. This descriptive statistics comprise signature data.

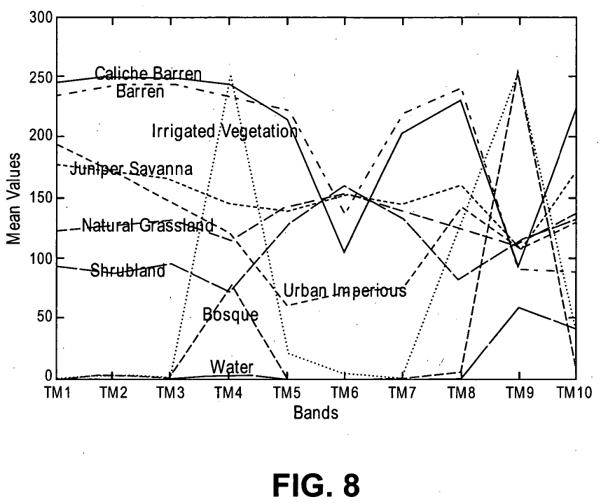

The signature mean is plotted in FIG. 8. As shown in FIG. 8, some classes have very similar statistics, such as natural grassland and shrubland or barren and caliche-barren. Such signature information may be utilized in building and training HFNN 600. In total, 9,968 ground truth points are collected from the ROIs of which 4,901 points are randomly selected to be used as the training data and the other 32 areas are used as the testing data. Table 2 describes the number of pixels of the land cover classes for the training data and testing data.

TABLE 2

| Class | Training Data (4901/37) | Testing Data (5068/32) |
|---|---|---|
| Water | 265/3 | 303/2 |
| Urban Imperious | 977/6 | 1394/6 |
| Irrigated Vegetation | 709/4 | 601/4 |
| Barren | 1729/8 | 1746/7 |
| Caliche-Barren | 133/2 | 70/1 |
| Bosque | 124/2 | 74/1 |
| Shrubland | 470/5 | 453/5 |
| Natural Grassland | 229/4 | 263/3 |
| Juniper Savanna | 265/3 | 164/3 |

HFNN 600 includes eight fuzzy neural networks 602, 604, 606, 608, 610, 612, 614, and 616 arranged in a four layer hierarchical structure. In each FNN of HFNN 600, the input variable is represented by two Gaussian combination membership functions. Neural networks 602, 604, 608, 610, 612, and 616 are two-input FNNs. As such, each of neural networks 602, 604, 608, 610, 612, and 616 includes four rules. Neural networks 606 and 614 are three-input neural networks. As such, each of neural networks 606 and 614 includes eight rules. HFNN includes a total of 40 rules (4×6+8×2).

To determine the arrangement of HFNN 600, the classes were grouped together. Then each group was further divided into sub-groups. Expert knowledge may be utilized to determine the division and sub-division of the classes. The classes found in each group and sub-group may be grouped according to their similarities.

By dividing the classes into groups, all inputs are not applied to HFNN 600 at the same time for the classification. As such, only the 40 rules are required. The input of FNNS 602, 604, 608, 610, 612, and 616 may be selected with the biggest signature mean difference of the two output classes. This may be determined using the data in FIG. 8. Each FNN is limited to two or three inputs. Table 3 discloses the input and output arrangement for HFNN 600.

TABLE 3

| | | First Output | Second Output |
|---|---|---|---|
| FNN | Input | Classes | Classes |
| 602 (First level) | TM5, TM7 | WT, UI, | BR, CB, SB, |
| | | IV, BQ | NG, JS |
| 604 (Second level) | TM9, First Output | IV, BQ | WT, UI |
| | 602 | | |
| 606 (Second Level) | Second Output 602, | BR, CB | SB, NG, JS |
| | TM3, TM8 | | |
| 608 (Third Level) | TM8, First Output | IV | BQ |
| | 604 | | |
| 610 (Third Level) | Second Output 604, | WT | UI |
| | TM1 | | |
| 612 (Third Level) | TM10, First Output | BR | CB |
| | 606 | | |
| 614 (Third Level) | Second Output 606, | JS | SB, NG |
| | TM1, and TM10 | | |
| 616 (Fourth Level) | Second output 614, | SB | NG |
| | TM7 | | |

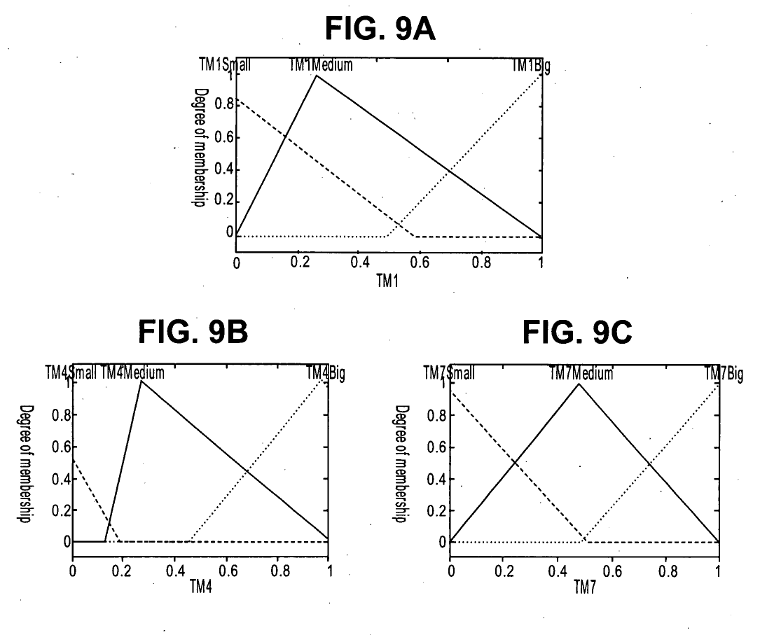

The Landsat ETM+ image was also classified using linear FNNs for three input bands TM1, TM4, and TM7, to determine the classes. The FNNs include membership function as illustrated in FIGS. 9A-9C with 3 input bands, TM1, TM4, and TM7. FIG. 9A is a diagram illustrating the membership function for TM1. FIG. 9B is a diagram illustrating the membership function for TM4. FIG. 9C is a diagram illustrating the membership function for TM7. The membership functions are used to represent each input variable and output a constant.

The FNNs also include 27 rules for each class. A total of 243 rules are used in the classification. A hybrid learning algorithm is used to train the FNNs. Then, expert knowledge is utilized to modify the rules to better facilitate classification of the image. The rule base for class was modified to produce a constant output. The following are 4 examples of the 27 rules for WT which were modified:

IF TM1 is TM1Small and TM4 is TM4Small and TM7 is TM7Small Then WT is S1;

IF TM1 is TM1Small and TM4 is TM4Small and TM7 is TM7Medium Then WT is S2;

IF TM1 is TM1Big and TM4 is TM4Big and TM7 is TM7Medium Then WT is S26; and

IF TM1 is TM1 Big and TM4 is TM4Big and TM7 is TM7Big Then WT is S27;

where Table 4 are the constant Si where I=1 to 27.

TABLE 4

| | | | | |
|---|---|---|---|---|
| S1: 0.999 | S2: −0.222 | S3: 3.800 | S4: 0.015 | S5: −0.001 |
| S6: 0.006 | S7: 0.001 | S8: −0.010 | S9: 0.002 | S10: −0.349 |
| S11: 0.093 | S12: −1.588 | S13: −0.001 | S14: 0 | S15: 0 |
| S16: −0.003 | S17: 0 | S18: 0 | S19: −0.022 | S20: 0.043 |
| S21: 0 | S22: 0 | S23: 0 | S24: 0 | S25: 0 |
| S26: 0 | S27: 0 | | | |

The above classification with the FNNs was preformed with 3 input bands.

The Landsat ETM+ image was also classified using linear FNN 700 as illustrated in FIG. 7. FNN 700 comprises a series of FNNs 702. Seven input band, TM1, TM3, TM5, TM7, TM8, TM9, and TM10, were applied to FNN 700 to determine the classes. When FNN 700 was used with 7 bands, the number of rules for FNN 700 was 1152 (2⁷×9), where each input variable is represented by two membership functions. The following are examples of rules for the water class:

IF TM1 is TM1Small and TM3 is TM3Small and TM5 is TM5Small and TM7 is TM7Small and TM8 is TM8Small and TM9 is TM9Small and TM10 is TM10Small, THEN WT is S1;

IF TM1 is TM1Small and TM3 is TM3Small and TM5 is TM5Small and TM7 is TM7Small and TM8 is TM8Small and TM9 is TM9Small and TM10 is TM10Big, THEN WT is S2;

IF TM1 is TM1 Big and TM3 is TM3Big and TM5 is TM5Big and TM7 is TM7Big and TM8 is TM8Big and TM9 is TM9Big and TM10 is TM10Small, THEN WT is S127;

IF TM1 is TM1 Big and TM3 is TM3Big and TM5 is TM5Big and TM7 is TM7Big and TM8 is TM8Big and TM9 is TM9Big and TM10 is TM10Big, THEN WT is S128;

The overall and average accuracy for FNN 700 using the data for this example was 79.1% and 73.97%(for the FNN with 7 input bands). The overall and average accuracy of HFNN 600 using the data for this example was 89.29% and 87.9%, respectively. HFNN 600 was 10% and 14% higher in overall and average accuracy, respectively, than that of a FNN classification. Additionally, HFNN 600 classifies quicker than a FNN classification. For example, HFNN 600 running on a PENTIUM IV 2.2 GHz computer required 233 s or 2.7 minutes. FNN 700 running the same image on the same system requires 10070 s or 2.8 hours, almost 45 times HFNN 600 running time.

Other embodiments will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for classifying data, comprising:
receiving data representing an object to be classified into classes;
applying the data to a hierarchical fuzzy neural network, wherein the hierarchical fuzzy neural network comprises multiple fuzzy neural networks arranged in a hierarchical structure; and
classifying the data using the hierarchical fuzzy neural network.

2. The method of claim 1, wherein the data comprises multiple sets of data representing the object, each set of the multiple data sets including different information about the object.

3. The method of claim 1, further comprising:
building the hierarchical fuzzy neural network; and
training the hierarchical fuzzy neural network using training data.

4. The method of claim 3, wherein building the hierarchical fuzzy neural network comprises:
grouping the classes based on a relationship of the classes; and
arranging the fuzzy neural networks at hierarchy levels in the hierarchical fuzzy neural network based on the relationship of the classes.

5. The method of claim 4, wherein the classes are grouped using expert knowledge.

6. The method of claim 4, wherein the fuzzy neural networks are arranged using expert knowledge.

7. The method of claim 3, wherein training the hierarchical fuzzy neural network comprises:
determining the training data for the fuzzy neural networks in the hierarchical fuzzy neural network;
training the fuzzy neural networks using the training data to determine rules for the fuzzy neural networks; and
modifying the rules in the fuzzy neural networks, based on the training.

8. The method of claim 7, wherein the fuzzy neural network are trained using expert knowledge.

9. An apparatus configured to perform the method of claim 1.

10. A system for classifying data, comprising:
an input for receiving data representing an object to be classified into classes; and
a processor configured to apply the data to a hierarchical fuzzy neural network, and classify the data using the hierarchical fuzzy neural network, wherein the hierarchical fuzzy neural network comprises multiple fuzzy neural networks arranged in a hierarchical structure.

11. The system of claim 10, wherein the processor is configured to build the hierarchical fuzzy neural network, and train the hierarchical fuzzy neural network using training data.

12. The system of claim 11, wherein the processor is configured to group the classes based on a relationship of the classes and arrange the fuzzy neural networks at hierarchy levels in the hierarchical fuzzy neural network based on the relationship of the classes.

13. The system of claim 12, wherein the processor is configured to group the fuzzy neural networks using expert knowledge.

14. The system of claim 12, wherein the processor is configured to arrange the fuzzy neural networks using expert knowledge.

15. The system of claim 11, wherein the processor is configured to determine the training data for the fuzzy neural networks in the hierarchical fuzzy neural network, train the fuzzy neural networks using the training data to determine rules for the fuzzy neural networks, and modify the rules in the fuzzy neural networks based on the training.

16. The system of claim 15, wherein the processor is configured to train the fuzzy neural networks using expert knowledge.

17. A method of classifying image data, comprising:
receiving data representing an object to be classified into classes, the data comprises multiple sets of data representing the object, each set of the multiple data sets including different information about the object;
building a fuzzy neural network using expert knowledge;
applying the data to the fuzzy neural network; and
classifying the data using the fuzzy neural network.

18. The method of claim 17, wherein building the fuzzy neural network comprises:
applying training data to the fuzzy neural network; and
modifying a rule of the fuzzy neural network based on an output of the fuzzy neural network from the training data and expert knowledge.

19. The method of claim 18, wherein applying training data comprises: applying a learning algorithm.

20. An apparatus configured to perform the method of claim 17.
